(19) United States
(12) Patent Application Publication
(10) Pub. No.: US 2026/0175370 A1
(43) Pub. Date: Jun. 25, 2026

(54) TOOL

(71) Applicant: Stanley Black & Decker MEA FZE, Dubai (AE)

(72) Inventors: Li Yu WANG, Taipei (TW); Chun Peng LIN, Taipei (TW)

(21) Appl. No.: 19/428,461

(22) Filed: Dec. 22, 2025

(30) Foreign Application Priority Data
Dec. 23, 2024 (EP) 24222943.3

(51) Int. Cl. B25B 13/06

(52) U.S. Cl. CPC B25B 13/065

(57) ABSTRACT

A tool for driving a fastener about a tool centre is provided. The fastener comprises a first fastener corner and a second fastener corner and a first fastener flat surface extending therebetween. The tool also comprises a socket having a first tool recess arranged to receive the first fastener corner and a second tool recess arranged to receive the second fastener corner and a first protruding portion between the first tool recess and the second tool recess. The first protruding portion is arranged to engage the first fastener flat surface and position the fastener into an offset centre position wherein a fastener centre of the fastener is offset from the tool centre.

### CROSS-REFERENCE TO RELATED APPLICATION

The subject application claims priority to and the benefit of EP Application Serial No. 24222943.3 filed on Dec. 23, 2024, the entire contents of which are hereby incorporated by reference.

### FIELD

The present disclosure relates to a tool. In particular the present disclosure relates to a socket, a nut driver or a wrench.

### BACKGROUND

It is known to use tools such as wrenches and sockets to fasten different types of fastener heads. However, over time a fastener may become worn, and the corners of the fastener may become rounded. This means that a socket or wrench may no longer be effective at fastening or loosening the fastener and even further round the corners of the fastener.

It is known to alter the profile of various wrenches, e.g. such as shown in U.S. Pat. No. 9,718,170. However, a problem with this arrangement is that the tool is most effective when the corners of the fastener are evenly worn.

### SUMMARY

Examples of the present disclosure aim to address the aforementioned problems.

According to an aspect of the present disclosure there is a tool for driving a fastener about a tool centre, the fastener comprising a first fastener corner and a second fastener corner and a first fastener flat surface extending therebetween; the tool comprising: a socket having a first tool recess arranged to receive the first fastener corner and a second tool recess arranged to receive the second fastener corner and a first protruding portion between the first tool recess and the second tool recess; wherein the first protruding portion is arranged to engage the first fastener flat surface and position the fastener into an offset centre position wherein a fastener centre of the fastener is offset from the tool centre.

Optionally the first protruding portion is distal from a midpoint between the first tool recess and the second tool recess of the tool.

Optionally the fastener comprises a third fastener corner and a second fastener flat surface extending between the third fastener corner and the first fastener corner wherein the socket comprises a third tool recess arranged to receive the third fastener corner and a second protruding portion between the first tool recess and the third tool recess.

Optionally the second protruding portion distal from a midpoint between the first tool recess and the third tool recess of the tool.

Optionally the fastener comprises a fourth fastener corner and a third fastener flat surface extending between the fourth fastener corner and the second fastener corner wherein the socket comprises a fourth tool recess arranged to receive the fourth fastener corner and a third protruding portion between the second tool recess and the fourth tool recess.

Optionally the third protruding portion distal from a midpoint between the second tool recess and the fourth tool recess of the tool.

Optionally the first protruding portion comprises a first inclined portion and a second inclined portion and a protrusion flat surface between the first inclined portion and the second inclined portion.

Optionally a distance from a first centre point of the first tool recess to the first inclined portion is between 18% to 26% of the distance between the first centre point and a second centre point of the second tool recess.

Optionally the angle of inclination between the first inclined portion and a nominal line between a first centre point of the first tool recess and a second centre point of the second tool recess is between 4 degrees and 7 degrees.

Optionally a distance from a first centre point of the first tool recess to the second inclined portion is between 70% to 90% of the distance between the first centre point and a second centre point of the second tool recess.

Optionally the angle of inclination between the protrusion flat surface and the second inclined portion is between 135 degrees to 140 degrees.

Optionally the socket comprises an asymmetric cross section.

Optionally the tool is a nut driver, a socket driver or a wrench.

### BRIEF DESCRIPTION OF THE DRAWINGS

Various other aspects and further examples are also described in the following detailed description and in the attached claims with reference to the accompanying drawings, in which:

FIG. 1 shows a perspective view of the tool and a fastener according to some examples;

FIG. 2 shows a partial cross-sectional view of the tool according to some examples;

FIG. 3 shows a close-up view of the profile of one of the sides of the tool as shown in FIG. 2 according to some examples.

FIG. 4 shows a cross-sectional view of the tool according to some examples;

FIG. 5 shows another cross-sectional view of the tool together with the fastener according to some examples;

FIG. 6 shows a cross-sectional view of the tool together with the fastener when the tool is loosening the fastener according to some examples;

FIG. 7 shows a cross-sectional view of the tool together with the fastener when the tool is tightening the fastener according to some examples;

FIG. 8 shows a plan view of the fastener;

FIG. 9 shows a plan view of the fastener with rounded; and

FIGS. 10 to 13 show a schematic representation of different examples of the tool according to some examples.

### DETAILED DESCRIPTION

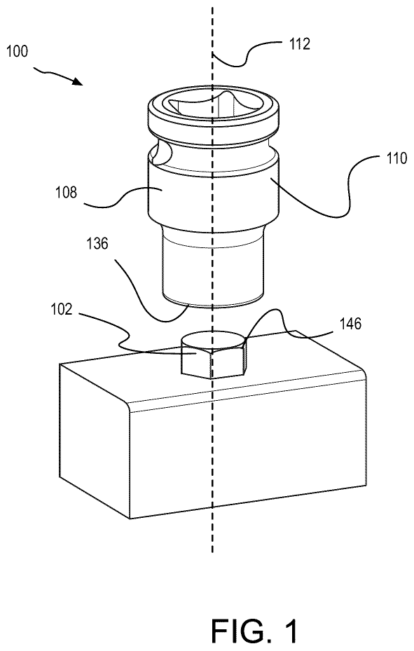

FIG. 1 shows a perspective view of a tool 100 together with a fastener 102. The fastener 102 is typically a hexagonal fastener 102, for example a bolt. However, in other examples, the fastener 102 may have a different shaped head, e.g. square, triangular, pentagonal etc.

The tool 100, as shown in FIG. 1, is a socket wrench. However, in other examples, the tool 100 can be any suitable tool for fastening or loosening a fastener 102, e.g. a hexagonal fastener 102, such as a wrench, etc. The tool 100, as shown in FIG. 1, comprises a tool body 110, which extends along a longitudinal axis 112. The tool 100 comprises a socket 108, having a socket cavity 136, with a specific cross-sectional geometry. The cross-sectional geometry will be discussed in more detail below.

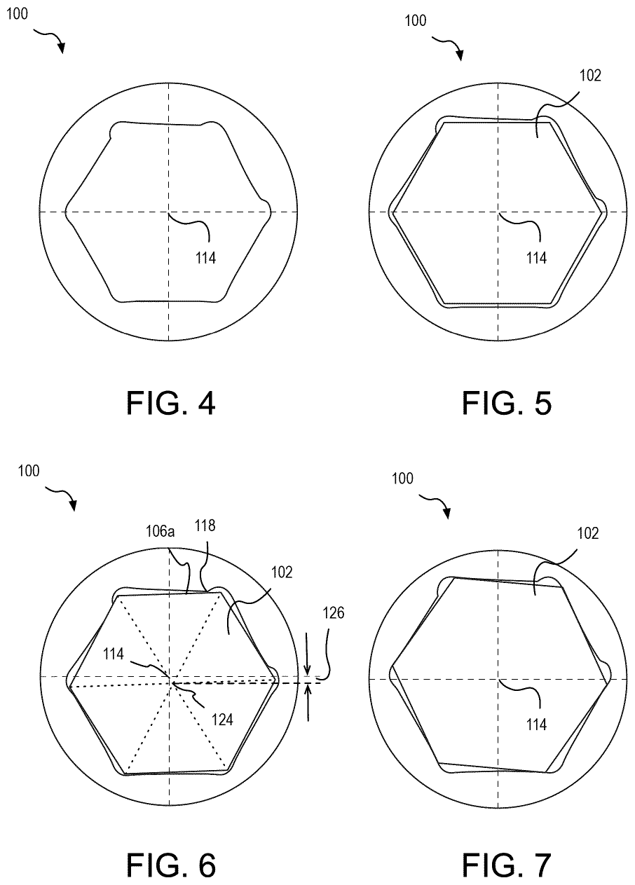

The longitudinal axis 112 of the tool 100 is aligned with a tool centre 114, which is best shown in e.g. FIG. 4. The tool centre 114 is a centre point of the tool 100, and in use the tool 100 rotates about the tool centre 114 and the longitudinal axis 112 when loosening or fastening the fastener 102.

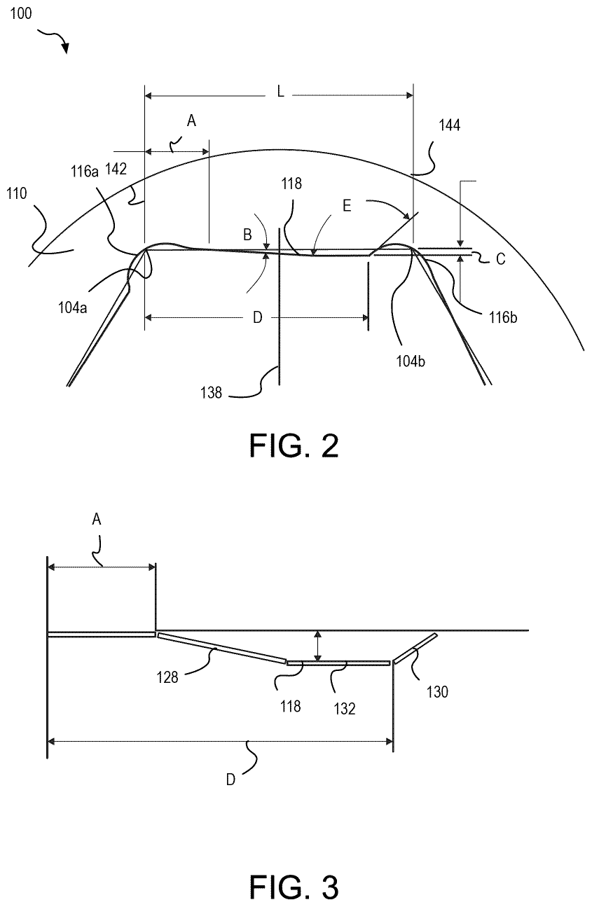

The profile and cross-sectional geometry of the tool 100 will now be discussed in more detail with respect to FIGS. 2 and 3. FIG. 2 shows a partial cross-sectional view of the tool 100. The socket cavity 136 comprises a plurality of tool recesses 116 for receiving a fastener corner 104.

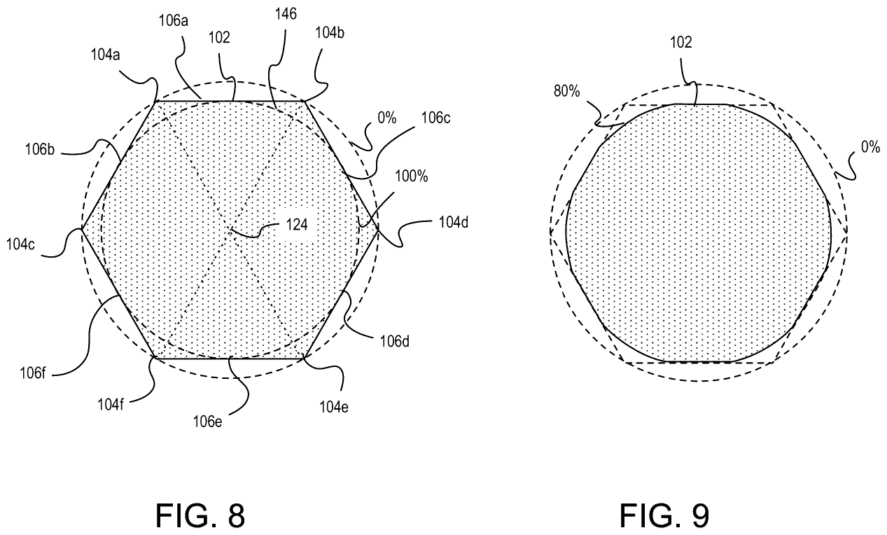

As can be seen from FIG. 2, the tool 100 comprises a first tool recess 116a and a second tool recess 116b. The first tool recess 116a and the second tool recess 116b are arranged to respectively receive a first fastener corner 104a and a second fastener corner 104b. Since the tool 100 is configured to tighten and loosen a fastener 102 with a hexagonal fastener head, the tool 100 comprises six tool recesses 116 respectively arranged to engage six fastener corners 104. The first fastener corner 104a is centred on a first centre point 142 as shown in FIG. 2. Similarly, the second tool recess 116b is centred on a second centre point 144. The first tool recess 116a and the second tool recess 116b are arranged to respectively receive the first fastener corner 104a and the second fastener corner 104b irrespective of the state of wear (e.g. the roundedness of the corners 104, best shown in FIGS. 8 and 9 below) of the first fastener corner 104a and the second fastener corner 104b.

The first tool recess 116a and the second tool recess 116b are aligned along one side of the socket cavity 136, corresponding to a side of the fastener 102 when the fastener 102 is inserted into the tool 100. The tool 100 comprises a first protruding portion 118 between the first tool recess 116a and the second tool recess 116b.

As shown in FIG. 2, the first protruding portion 118 extends into the socket cavity 136. The first protruding portion 118 is arranged to engage a first fastener flat surface 106a. The first fastener flat surface 106a extends between the first fastener corner 104a and the second fastener corner 104b. The first protruding portion 118 advantageously engages the first fastener flat surface 106a and can impart a torque on the fastener head 146 in use. This means that if the corners 104 of the fastener 102 are worn, the tool 100 is still able to impart a torque to the fastener 102. This means that the tool 100 can effectively grip the worn fastener 102, but also not engage the first fastener corner 104a and the second fastener corner 104b which prevents further rounding of the corners 104 of the fastener 102.

Reference will now be briefly made to FIGS. 8 and 9. FIG. 8 shows a plan view of a fastener 102 and a fastener head 146. As shown in FIG. 8, the fastener 102 is not worn and comprises fully formed corners 104.

In particular, the fastener 102 comprises a first fastener corner 104a, a second fastener corner 104b, a third fastener corner 104c, a fourth fastener corner 104d, a fifth fastener corner 104e and a sixth fastener corner 104f. In between the corners 104 extend flat surfaces. In particular, a first fastener flat surface 106a extends between a first fastener corner 104a and a second fastener corner 104b. A second fastener flat surface 106b extends between the first fastener corner 104a and the third fastener corner 104c. A third fastener flat surface 106c extends between the second fastener corner 104b and a fourth fastener corner 104d. A fourth fastener flat surface 106d extends between the fourth fastener corner 104d and a fifth fastener corner 104e. A fifth fastener flat surface 106e extends between a fifth fastener corner 104e and a sixth fastener corner 104f.

Finally, a sixth fastener flat surface 106f extends between the sixth fastener corner 104f and the third fastener corner 104c.

FIG. 8 also shows a nominal circle which indicates a zero percentage wear of the fastener 102 when there is no wear on the fastener 102. This represents a new fastener 102 without any wear. The tips of the unworn fastener corners 104 of the fastener 102 touch the zero percentage circle as shown in FIG. 8. When the corners 104 of the fastener 102 are fully worn, then the fastener 102 forms a circle indicated by the 100% worn circle. In other words, the hexagonal shaped fastener 102 has worn down to the maximum size circle that fits within the hexagon as shown in FIG. 8. In between the two extremes of 100% worn and 0% worn, the corners 104 of the fastener 102 can be partially worn. For example, as shown in FIG. 9, the fastener 102 comprises corners 104 which are worn to 80%.

FIG. 8 also shows a fastener centre 124 of the fastener 102. The fastener centre 124 is the centre of the fastener 102 as defined by the intersection between diametrically opposite lines between opposite fastener corners 104. When there is no wear on the fastener 102, the fastener centre 124 will be concentric with the longitudinal axis 112 and the tool centre 114. However, when the fastener 102 experiences wear, then the fastener centre 124 will be offset from the tool centre 114 when the tool 100 is used to rotate the fastener 102 as discussed below.

Turning briefly to FIG. 12, the various tool recesses 116 will now be discussed. As mentioned above, the tool 100 comprises a socket cavity 136 arranged to engage a hexagonal fastener 102. Accordingly, the tool 100 comprises a first tool recess 116a, a second tool recess 116b, a third tool recess 116c, a fourth tool recess 116d, a fifth tool recess 116e and a sixth tool recess 116f.

The first tool recess 116a, the second tool recess 116b, the third tool recess 116c, the fourth tool recess 116d, the fifth tool recess 116e, the sixth tool recess 116f are arranged to respectively engage the first fastener corner 104a, the second fastener corner 104b, the third fastener corner 104c, the fourth fastener corner 104d, the fifth fastener corner 104e and the sixth fastener corner 104f.

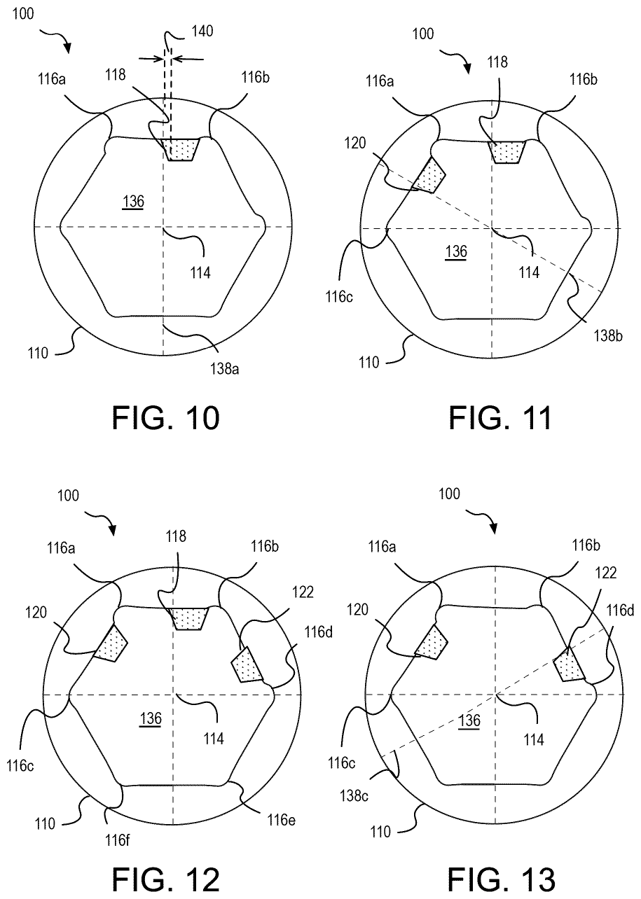

Turning back to FIGS. 2 and 3, the profile of the first protruding portion 118 will now be discussed in more detail. The first protruding portion 118, as discussed above, extends into the socket cavity 136. FIG. 2 shows a centreline 138 of the tool 100 which is aligned with the tool centre 114. The tool 100 is arranged such that the first protruding portion 118 is offset from the centreline 138 which is a midpoint between the nominal line between the first centre point 142 of the first tool recess 116a to a second centre point 144 of the second tool recess 116b. FIGS. 10, 11 and 13 show further examples of centrelines 138a, 138b, 138c aligned with the tool centre 114. The centrelines 138a, 138b, 138c respectively corresponding to a midpoint between the nominal line between the first centre point 142 of the first tool recess 116a to a second centre point 144 of the second tool recess 116b, a midpoint between the nominal line between a first centre point 142 of the first tool recess 116a to a centre point of the third tool recess 116b, and a centre point of the fourth tool recess 116d to a second centre point 144 of the second tool recess 116b. The examples shown in FIGS. 10, 11 and 13 are discussed in more detail below.

This means that the cross-sectional shape of the tool 100 is asymmetric by virtue of the profile and e.g. the first protruding portion 118. The asymmetric shape causes the fastener 102 to move with respect to the tool 100 during use. This means that the flat surfaces e.g. the first fastener flat surface 106a engages the first protruding portion 118 during use. This means that the first tool recess 116a and the second tool recess 116b do not engage the corresponding first fastener corner 104a and second fastener corner 104b if the first fastener corner 104a and the second fastener corner 104b are worn. This is discussed in more detail below.

The first protruding portion 118 comprises a first inclined portion 128 and a second inclined portion 130. A protrusion flat surface 132 extends between the first inclined portion 128 and the second inclined portion 130. The protrusion flat surface 132 is arranged to engage a surface of the fastener 102 in use. For example, the protrusion flat surface 132 engages the first fastener flat surface 106a when the tool 100 is loosened, e.g. as shown in FIG. 6.

As shown in FIG. 2, the tool side length L is defined by a distance between a first centre point 142 of the first tool recess 116a to a second centre point 144 of the second tool recess 116b. A first side portion length A is defined as a distance from the first centre point 142 to the start of the first inclined portion 128.

A second side portion length D is defined as a distance from the first centre point 142 to the start of the second inclined portion 130. In this way, FIG. 2 indicates a first side portion length A and a second side portion length D. The first side portion length A and the second side portion length D are, in some examples, a proportion of the full tool side length L.

In some examples, the first side portion length A can be between 0.18L to 0.26L. Likewise, the second side portion length D, in some examples, can be between 0.7L to 0.9L.

In some examples, the angle of inclination B between the first inclined portion 128 and a nominal line between the first centre point 142 and the second centre point 144 is between 4 degrees and 7 degrees. An angle of inclination E between the protrusion flat surface 132 and the second incline portion 130 is between 135 degrees to 140 degrees.

As shown in FIG. 2 and FIG. 3, the tool 100 comprises a first protruding portion 118. In this way, in one example, the tool 100 comprises a single protruding portion, e.g. the first protruding portion 118.

However, in other examples, one or more protruding portions 118, 120, 122 can be provided to allow for additional engagement points for imparting torque between the tool 100 and the fastener 102. In some examples, which will now be discussed in reference to FIGS. 10 to 13, there are a plurality of protruding portions 118. 120, 122. FIGS. 10 to 13 schematically show the protruding portions 118, 120, 122 in the tool 100.

For example, FIG. 10 shows a schematic cross-sectional representation of the first protruding portion 118. Here, the first protruding portion 118 extends into the socket cavity 136. In addition, it can be noted that the first protruding portion 118 is offset from a centreline 138 by a protrusion offset 140.

FIG. 11 is the same as FIG. 10, except a second protruding portion 120 is also provided. Both the first protruding portion 118 and the second protruding portion 120 are on the same side of the tool centre 114. Both the first protruding portion 118 and the second protruding portion 120 are offset from a centreline 138 of the tool 100. This means that all of the first protruding portion 118, the second protruding portion 120 and the third protruding portion 122 are positioned in the same half of the cross-sectional shape of the socket cavity 136.

This means that the cross-sectional shape of the tool 100 is asymmetric as shown in FIG. 11. The second protruding portion 120 is the same as the first protruding portion 118 as discussed with reference to FIGS. 2 and 3 above. FIG. 11 shows the second protruding portion 120 also extending into the socket cavity 136 and is between the first tool recess 116a and the third tool recess 116c.

Furthermore, other examples and arrangements of the protruding portions 118, 120, 122 can be shown in FIGS. 12 and 13. FIG. 12 shows three protruding portions, e.g. a first protruding portion 118, a second protruding portion 120 and a third protruding portion 122. FIG. 12 shows the third protruding portion 122 also extending into the socket cavity 136 and is between the second tool recess 116b and the fourth tool recess 116d.

FIG. 12 is the same as FIG. 11, except that the third protruding portion 122 also protrudes into the socket cavity 136. Likewise, FIG. 12 also shows an asymmetric cross-section of the tool 100. Indeed, the first protruding portion 118, the second protruding portion 120 and the third protruding portion 122 are all on the same side of the tool centre 114.

FIG. 13 is the same as FIG. 12, except that the first protruding portion 118 has been omitted. However, the two protruding portions, e.g. the second protruding portion 120 and the third protruding portion 122 are arranged on the same side of the tool centre 114.

FIG. 5 shows the fastener 102 being inserted into the tool 100 with no torque being applied to the fastener 102. In contrast, FIG. 6 shows the tool 100 loosening the fastener 102 and the first protruding portion 118 is engaged with the first fastener flat surface 106a. Accordingly, this means that the fastener 102 is positioned with an offset 126 with respect to the tool 100. As shown in FIG. 6, the tool centre 114 is offset 126 by the distance indicated by 126 from the fastener centre 124. This means that the tool 100 can engage the sides of the fastener 102, e.g. the first fastener flat surface 106a without engaging the rounded corners 104.

FIG. 7 shows a corresponding representation of the fastener 102 being tightened by the tool 100. Again, the tool centre 114 is offset 126 by the distance indicated by 126 from the fastener centre 124.

This advantageously means that the tool 100 can tighten or loosen a fastener 102 with one or more rounded corners 104 without engaging the rounded corners 104. Furthermore, it does not matter if some or all of the corners 104 of the fastener 102 are worn or if the corners 104 are worn unevenly.

In another example, two or more examples are combined. Features of one example can be combined with features of other examples.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealised or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A tool for driving a fastener about a tool centre, the fastener comprising a first fastener corner and a second fastener corner and a first fastener flat surface extending therebetween; the tool comprising:
a socket having a first tool recess arranged to receive the first fastener corner and a second tool recess arranged to receive the second fastener corner and a first protruding portion between the first tool recess and the second tool recess;
wherein the first protruding portion is arranged to engage the first fastener flat surface and position the fastener into an offset centre position wherein a fastener centre of the fastener is offset from the tool centre.

2. The tool according to claim 1 wherein the first protruding portion is distal from a midpoint between the first tool recess and the second tool recess of the tool.

3. The tool according to claim 1 wherein the fastener comprises a third fastener corner and a second fastener flat surface extending between the third fastener corner and the first fastener corner wherein the socket comprises a third tool recess arranged to receive the third fastener corner and a second protruding portion between the first tool recess and the third tool recess.

4. The tool according to claim 3 wherein the second protruding portion distal from a midpoint between the first tool recess and the third tool recess of the tool.

5. The tool according to any of claim 3 wherein the fastener comprises a fourth fastener corner and a third fastener flat surface extending between the fourth fastener corner and the second fastener corner wherein the socket comprises a fourth tool recess arranged to receive the fourth fastener corner and a third protruding portion between the second tool recess and the fourth tool recess.

6. The tool according to claim 5 wherein the third protruding portion distal from a midpoint between the second tool recess and the fourth tool recess of the tool.

7. The tool according to claim 1 wherein the first protruding portion comprises a first inclined portion and a second inclined portion and a protrusion flat surface between the first inclined portion and the second inclined portion.

8. The tool according to claim 7 wherein a distance from a first centre point of the first tool recess to the first inclined portion is between 18% to 26% of the distance between the first centre point and a second centre point of the second tool recess.

9. The tool according to claim 7 wherein the angle of inclination between the first inclined portion and a nominal line between a first centre point of the first tool recess and a second centre point of the second tool recess is between 4 degrees and 7 degrees.

10. The tool according to claim 7 wherein a distance from a first centre point of the first tool recess to the second inclined portion is between 70% to 90% of the distance between the first centre point and a second centre point of the second tool recess.

11. The tool according to claim 7 wherein the angle of inclination between the protrusion flat surface and the second inclined portion is between 135 degrees to 140 degrees.

12. The tool according to claim 1 wherein the socket comprises an asymmetric cross section.

13. The tool according to claim 1 wherein the tool is a nut driver, a socket driver or a wrench.
